(19) United States
(12) Patent Application Publication
(10) Pub. No.: US 2016/0360161 A1
(43) Pub. Date: Dec. 8, 2016

(54) EXTERNAL SMARTPHONE OR TABLET CAMERA FOR USE IN PHYSICAL ACTIVITIES

(71) Applicant: Robert Edward Fitzgerald, North Barrington, IL (US)

(72) Inventor: Robert Edward Fitzgerald, North Barrington, IL (US)

(21) Appl. No.: 15/173,359

(22) Filed: Jun. 3, 2016

Related U.S. Application Data
(60) Provisional application No. 62/171,131, filed on Jun. 4, 2015.

(51) Int. Cl. H04N 7/18; H04N 5/232

(52) U.S. Cl. CPC H04N 7/185; H04N 5/23206

(57) ABSTRACT

A headgear mountable camera including a clip to mount the camera to a wearer/user, an image processing module, and wireless communications module. The wireless communications module can facilitate wireless data communications of video and audio to remote clients including smart hones and tablet computers, wherein the head mounted camera is mounted in at least one of: a sweatband, helmet, goggles, hat, and glasses. A camera that may be built into, mounted, and/or attachable/detachable as a camera lens to a variety of different headgear products and can transmit video data to computers, including portable handheld devices such as smartphones and tablets computers.

### INVENTION PRIORITY

The present application is a continuation of U.S. Provisional Application Ser. No. 62/171,131, filed Jun. 4, 2015, entitled “External Smartphone or Tablet Camera,” which is incorporated herein in its entirety for its teaching.

### TECHNICAL FIELD

The embodiments are related to wearable electronic devices. More particularly, the embodiments are related to wearable electronic devices in the form of external cameras and cameras adaptable as wearable, and to wired and wireless communication abilities including use of external cameras with handheld portable computing devices, including smartphone, tablets, encoders, and computers. More particularly, the embodiments relate to a camera that may be built into, mounted, and/or attachable/detachable as a camera lens to a variety of different headgear products and can transmits video data to computers, including portable handheld devices such as smartphones and tablets computers.

### BACKGROUND OF THE EMBODIMENTS

There is need for additional choice of camera viewing options from people engaged in physical activities. There is a need for hardware that can facilitate capturing and providing of alternate camera views from being involved in physical activities. There is a need to enable use of cameras to capture and provide physical activity in a hands free manner. There is a need to provide camera viewing options from the physical activity that can be used with smartphones/tablets instead of only using the existing camera built into the device. The smartphones/tablets all have built-in cameras (front and rear view camera) and when a person wishes to take video using these devices they must hold the device with their hands.

### SUMMARY OF THE EMBODIMENTS

There is therefore a need to have external camera lens choices that can be added to the current camera choices view, and that can operate as “hands-free” cameras.

It is a feature of the embodiment to provide external camera views from small cameras that can be attached to or embedded in headgear worn by users (e.g., athletes, divers, uniformed public servants) during activities, and to provide video from the headgear mounted cameras to computers.

It is also a feature of the embodiments that video from headgear mounted cameras can be delivered wirelessly to computers over short-range data connections (e.g., Bluetooth) or via wireless data communications networks (e.g.. Wi-Fi) either from a communication device associated with the camera or from smartphones and tablets themselves.

It is another feature that computer receiving video data from headgear mounted cameras can be provided as a separate hardware item that can be attached to or embedded in headgear of a user and can communicate with computers in the form of handheld computers, including smartphones, tablet computers, and laptops.

It is also a feature of the embodiments to provide choices of camera views to remote computer users not associated with the camera wearer.

It is also a feature of the embodiments that the headgear-mounted cameras can be operated as “hands-free” cameras.

### BRIEF DESCRIPTION OF THE DRAWINGS

FIG. illustrates a baseball cap with an integrated headgear camera and optional connectivity to a processing unit.

FIG. 2 illustrates eyeglasses with an integrated headgear camera, on board communications unit, and optional connectivity to an external processing unit.

FIG. 3 illustrates a baseball helmet with an integrated headgear camera, on board communications unit, and optional connectivity to an external processing unit.

FIG. 4 illustrates a hockey helmet with an integrated headgear camera, on board communications unit, and optional connectivity to an external processing unit.

FIG. 5 illustrates a goggle (ski or diving) with an integrated headgear camera, on board communications unit, and optional connectivity to an external processing unit.

FIG. 6 illustrates a service hat (e.g., police officer, etc.) with an integrated headgear camera, on board communications unit, and optional connectivity to an external processing unit.

FIG. 7 illustrates a diving helmet with an integrated headgear camera, on board communications unit, and optional connectivity to an external processing unit.

FIG. 8 illustrates a sweatband with an integrated headgear camera and optional connectivity to an external processing unit.

FIG. 9 illustrates a sweatband with an integrated headgear camera, on board wireless communications, processing unit, and optional connectivity to an external processing unit.

FIG. 10 illustrates a processing unit that can be connected to the headgear camera that is embedded in headgear.

FIG. 11 illustrates a processing unit providing data wirelessly (e.g., Wi-Fi, Bluetooth) to computing devices (e.g., smartphones, desktop computers, tablet computers, etc.).

FIG. 12 illustrates scenarios wherein headgear cameras communicate wirelessly to end user devices.

FIG. 13 illustrates scenarios wherein wireless communications for the embodiments can occur over various wireless communications networks worldwide.

FIG. 14 illustrates a camera usable in accordance with embodiments of the present invention.

FIG. 15 illustrates a diagram with a camera connectible to a portable handheld computer.

FIGS. 16 and 17 illustrate a clip for portable camera attachability and optional connection of the camera to a portable unit that can support power, processing, and wireless communications for the camera when in use.

FIG. 18 illustrates a baseball cap with a portable camera attached thereto and optional wired connectivity to a handheld computer.

FIG. 19 illustrates eyeglasses with a portable camera attached thereto and optional wired connectivity to a handheld computer.

FIG. 20 illustrates features of a portable camera that can be used with a clip and having wireless connectivity to a portable handheld computer.

FIG. 21 illustrates a portable camera clipped to various headgear with optional wireless connectivity to a handheld computer.

FIG. 22 illustrates a baseball cap with an integrated headgear camera incorporated in the bill of the hat and optional wireless connectivity to a handheld computer.

FIG. 23 illustrates a baseball cap with an integrated headgear camera and optional wired connectivity to a handheld computer.

FIG. 24 illustrates a portable camera directly attached to a portable electronic unit that can support any of: providing power, processing data (e.g., voice and video), and transmitting data to remote computers (e.g., servers, handheld computers).

FIG. 25 illustrates a portable electronic unit that can support any of: providing power, processing data (e.g., voice and video), and transmitting data to remote computers (e.g., servers, handheld computers).

FIG. 26 illustrates a power accessory that can be worn in association with headgear that can provide solar power to portable cameras and processing units.

FIG. 27 illustrates a power accessory connected with headgear to provide solar power to portable cameras and processing units located therein.

### DETAILED DESCRIPTION OF PREFERRED EMBODIMENTS

that can be wired or have a wireless connection using Wi-Fi/Bluetooth to send camera lens data signal to a smartphone/tablet with minimal delay in processing, almost instantaneously to smartphone/tablet/computer/encoder. This will provide a smartphone/tablet user a simple camera alternative to the existing camera built into their device and allow them to be able to send images from this external camera that is connected to the headwear/headgear to their smartphone/tablet. These camera lenses may be built-into many headwear components. When the camera lens is using a wireless signal, it will require a power source that can be built into the headwear or can be an “attachable/detachable” external power supply to power the wireless camera lens

Referring to FIG. 1, illustrated is a baseball cap 401 with an integrated headgear camera 332 with connectivity via wire 412 to other external components, such as a processing unit 450. Connectivity can be achieved via a USB cable 429. The processing unit can include an image processing unit 420, rechargeable battery 414, USB plug 413, and a wireless communications module 408 that can support Wi-Fi, Bluetooth, and/or cellular data network communications.

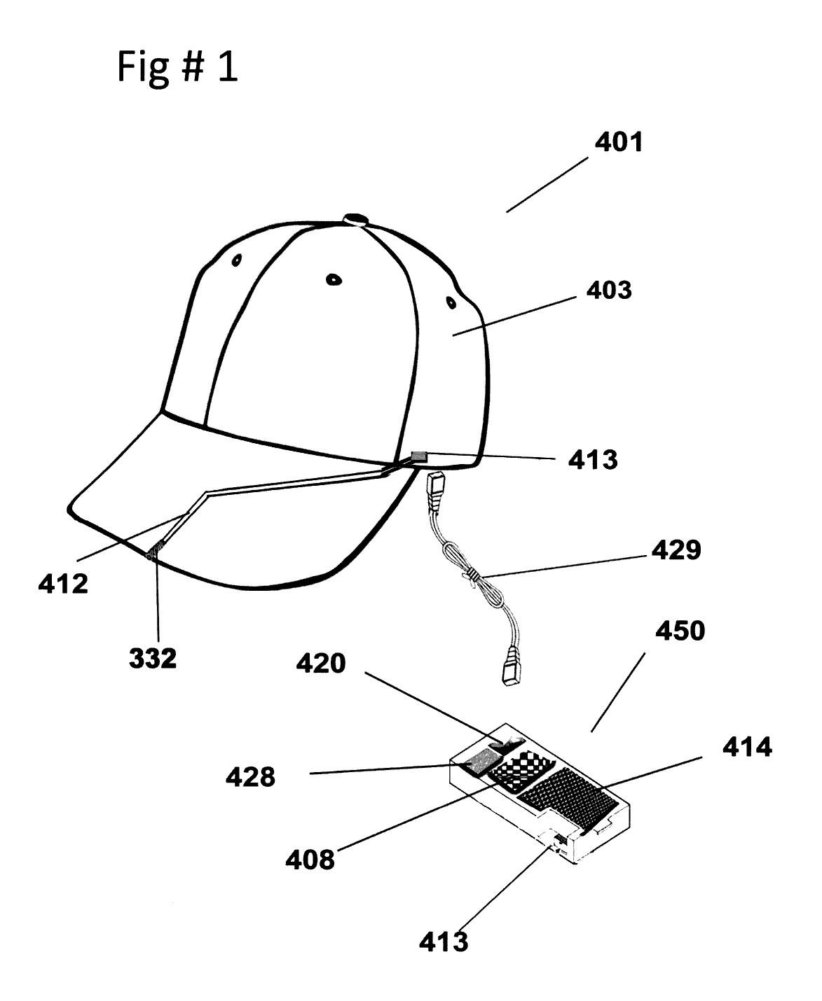

Referring to FIG. 2, illustrated are eyeglasses 501 having lenses 504 with an integrated headgear camera 332, on board communications unit 701, and optional connectivity via plug 413 and USB cable 429 to external processing unit 450.

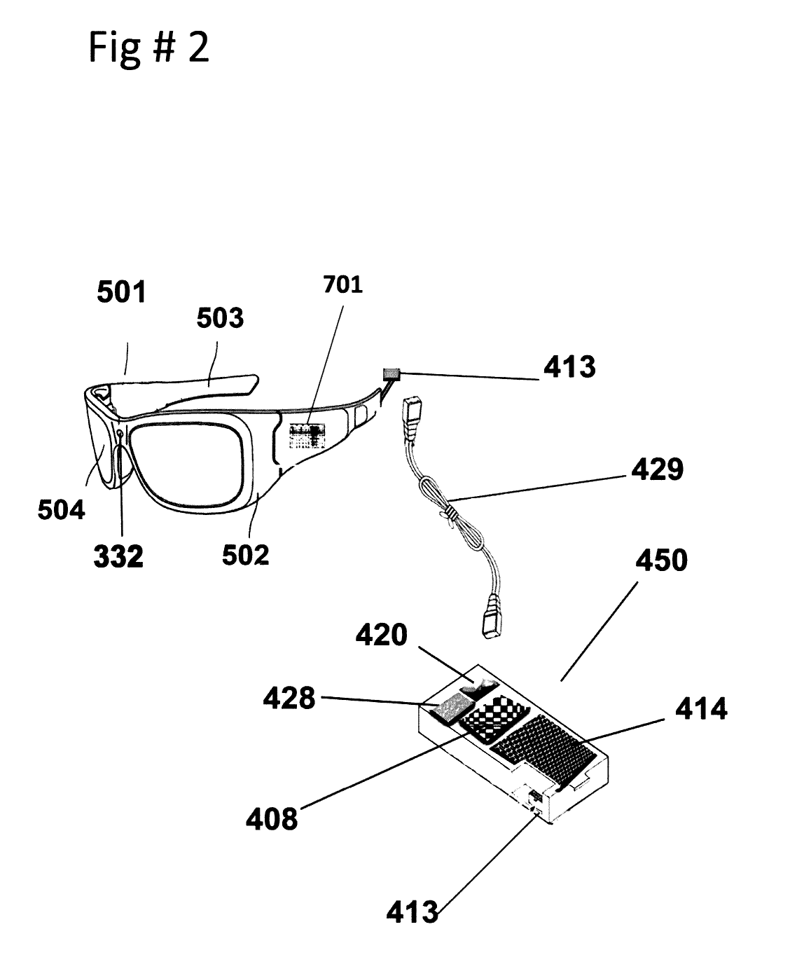

Referring to FIG. 3, illustrated is a baseball helmet 613 with an integrated headgear camera 332, on board communications unit 701, and optional connectivity via wire 412 to an external processing unit 450 via cabling 429.

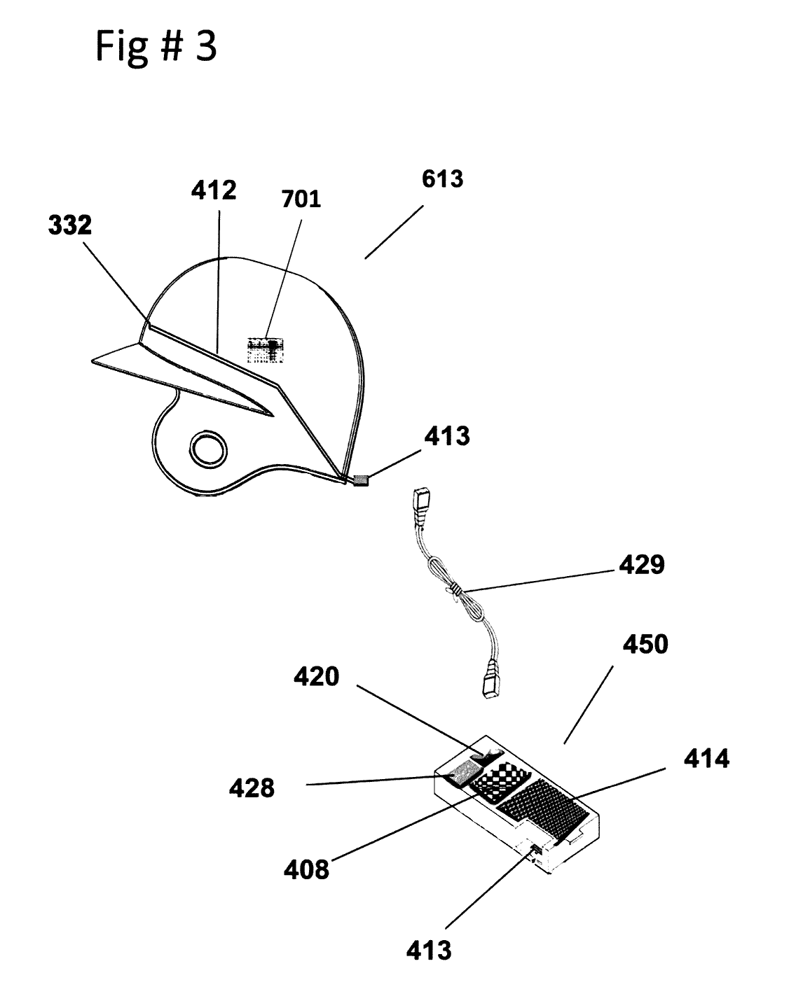

Referring to FIG. 4, illustrated is a hockey helmet 615 with an integrated headgear camera 332, on board communications unit 701, and optional connectivity via wire 412 to an external processing unit 450 via cabling 429.

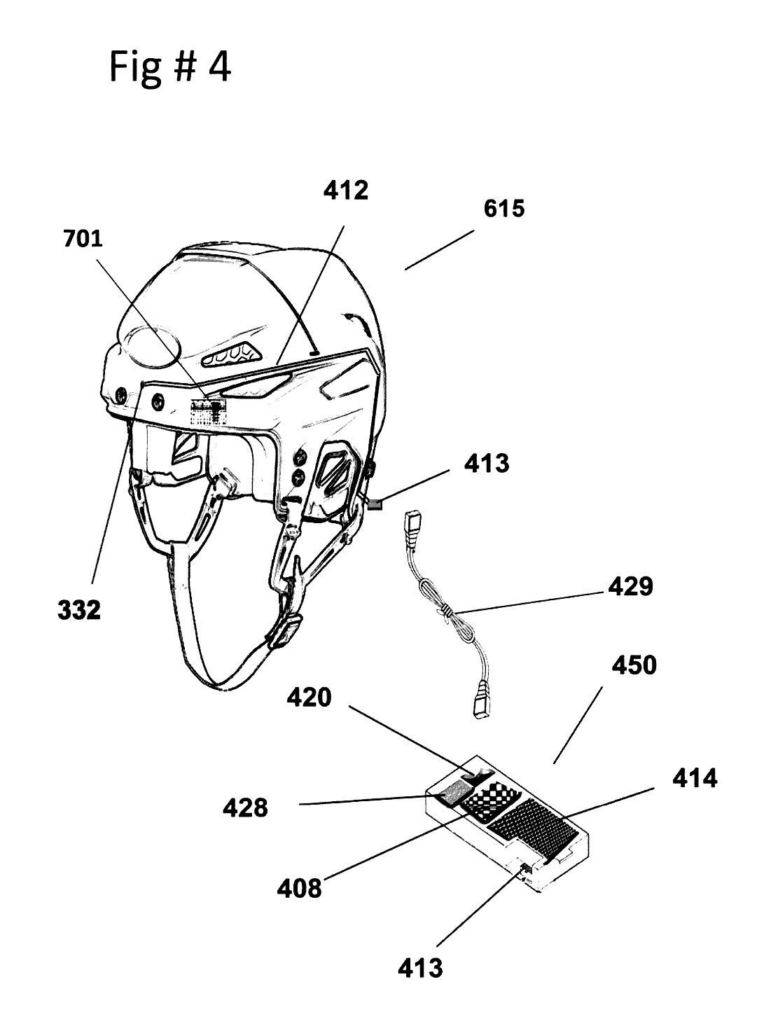

Referring to FIG. 5, illustrated is a goggle (ski or diving) 614 with an integrated headgear camera 332, on board communications unit 701, and optional connectivity via wire 412 to an external processing unit 450 via cabling 429.

Referring to FIG. 6, illustrated is a service hat (e.g., police officer, etc.) 616 with an integrated headgear camera 332, on board communications unit 701, and optional connectivity via wire 412 to an external processing unit 450 via cabling 429.

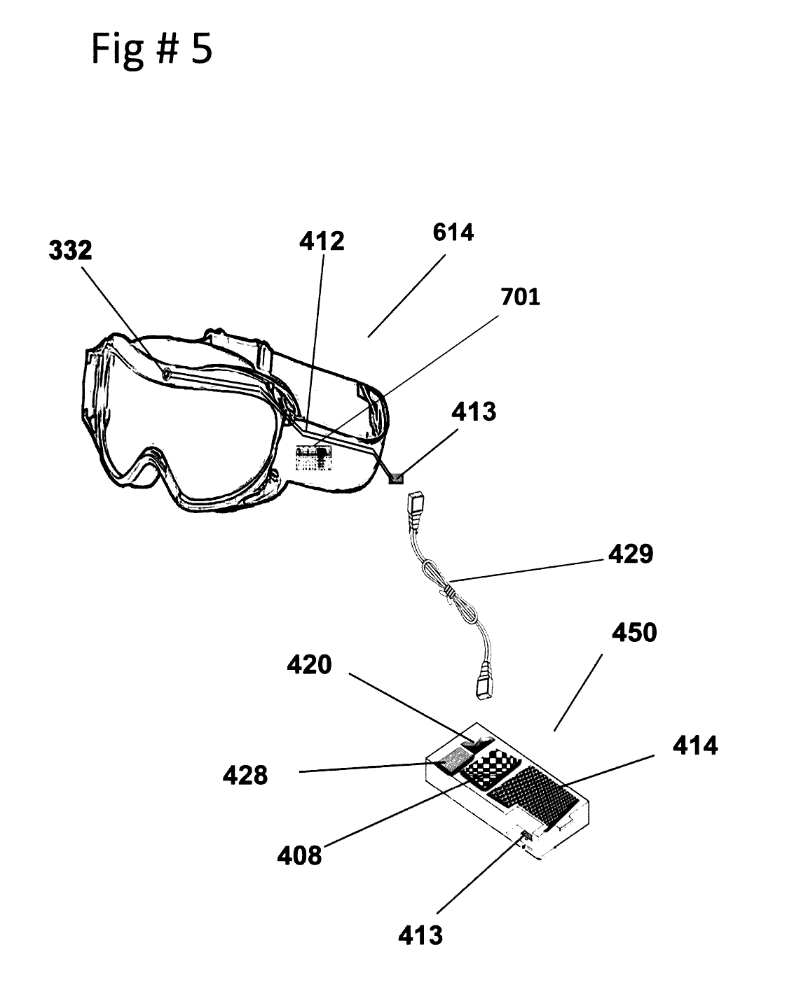

Referring to FIG. 7, illustrated is a diving helmet 617 with an integrated headgear camera 332, on board communications unit 701, and optional connectivity via wire 412 to an external processing unit 450 via cabling 429.

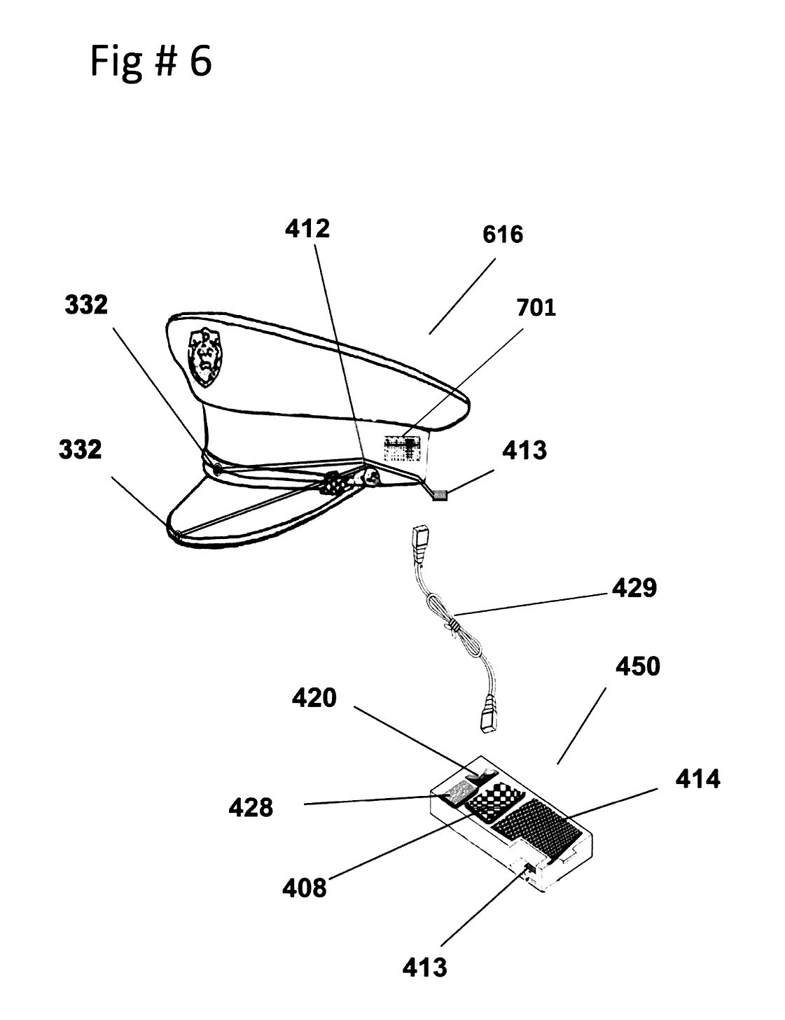

Referring to FIG. 8, illustrated is a sweatband 618 with optional connectivity via wire 412 to an external processing unit 450 via cabling 429.

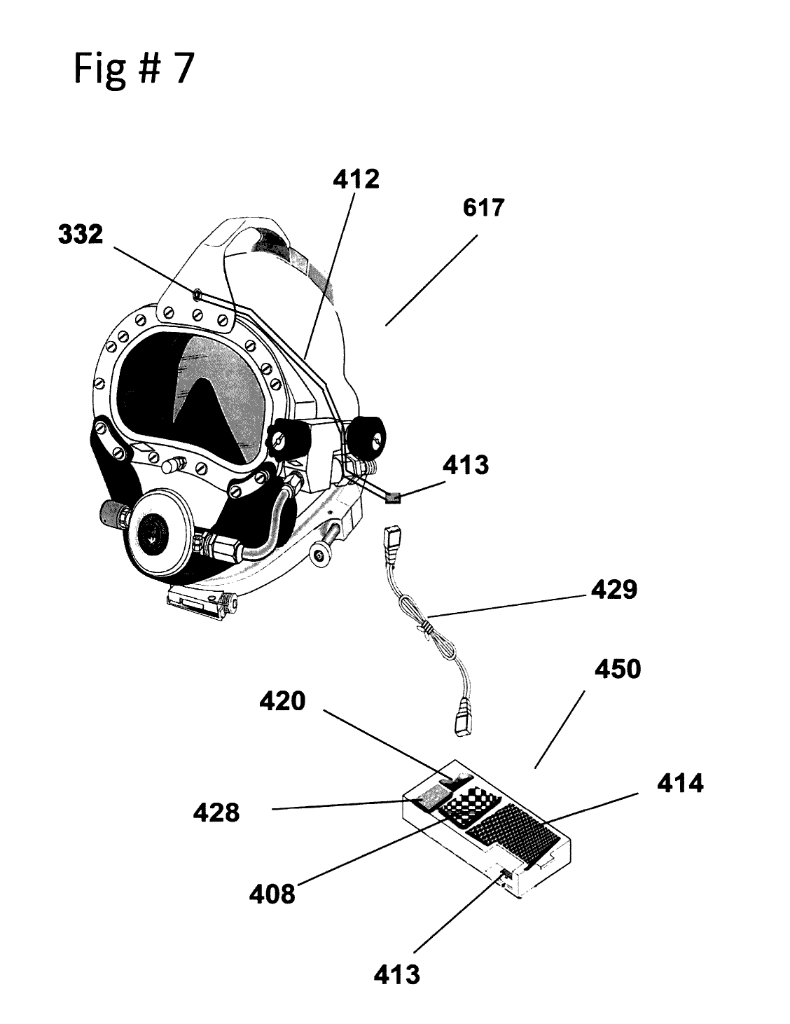

Referring to FIG. 9, illustrated is a sweatband 618 with an integrated headgear camera 332, on board short-range RF communications unit 701, wireless data network communications unit 408, processor 438, and optional connectivity via wire 412 to an external processing unit 450 via cabling 429.

Referring to FIG. 10, illustrated is a processing unit 651 that can be connected to the headgear camera that is embedded in headgear. The processing unit can include an image processing unit 420, rechargeable battery 414, USB plug 413, a wireless communications module 408 that can support Wi-Fi, Bluetooth and/or cellular data network communications, and audio processor 428.

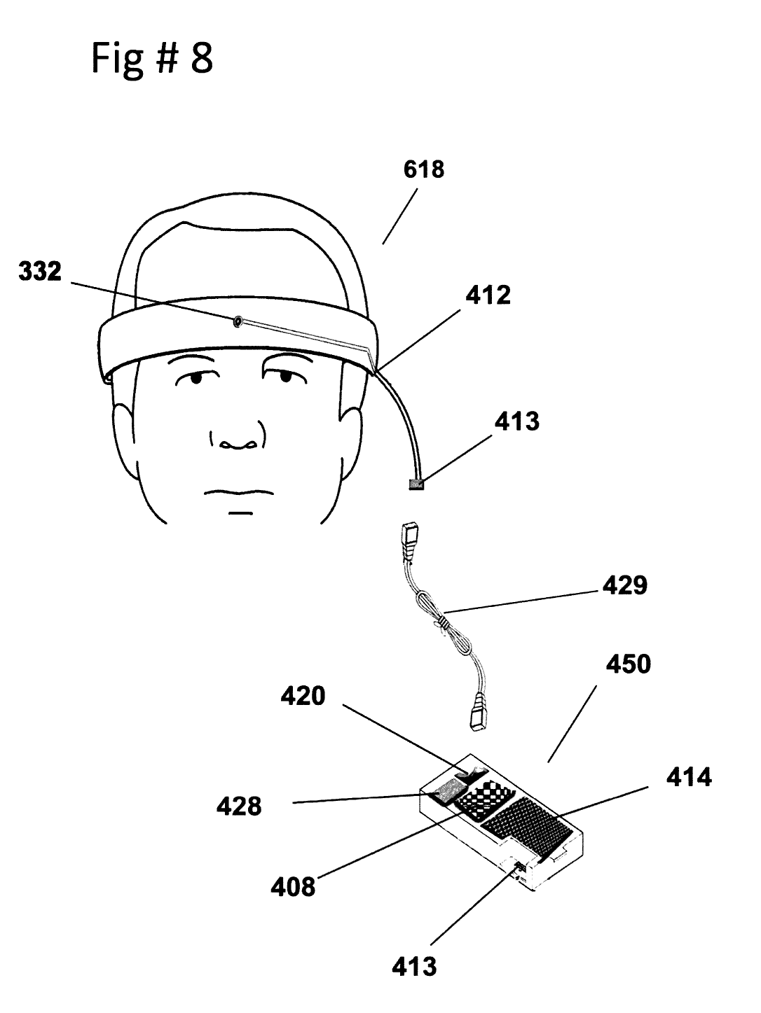

Referring to FIG. 11, illustrated is a processing unit 651 providing data (video and/or audio) obtained from headgear-mounted camera 332 wirelessly (e.g., Wi-Fi, Bluetooth) to computing devices, e.g., smartphones 461, desktop computers 421, tablet computers 463, other image processing components 464.

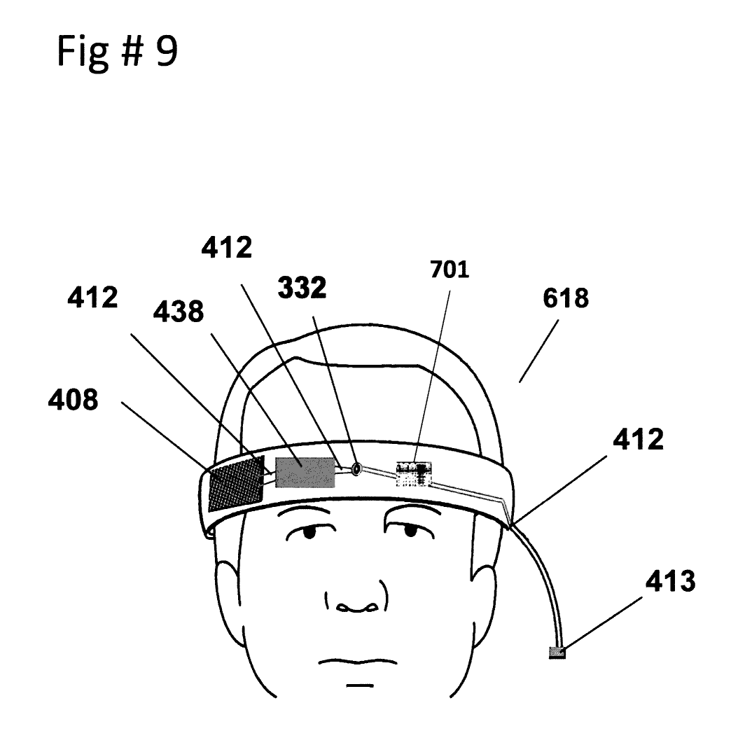

Referring to FIG. 12, illustrated is scenarios wherein headgear cameras 332 can communicate wirelessly to end user devices via wireless communications modules 701.

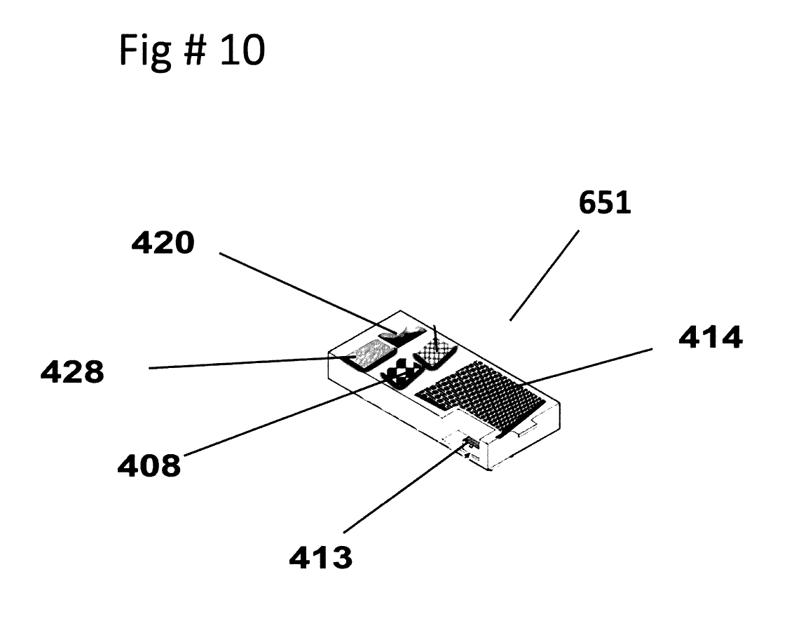

Referring to FIG. 13, illustrated is scenarios wherein wireless communications supported by wireless communications modules 701 can be sent directly (short range wireless data communications) and over various wireless communications networks to end users, worldwide.

In the following figures, headgear camera is equivalent to portable camera, but with the exception of actual headgear integration. Referring to FIG. 14, illustrated is a portable camera 332 that can include an optional microphone 333 and can be used in accordance with embodiments of the present invention to provide video and audio data to a processing unit, remote server, or portable computers (e.g., smartphones). The portable camera can include a lens 301, a housing 302, wiring 304, and a base 303 that can be attached to mounting hardware (not shown).

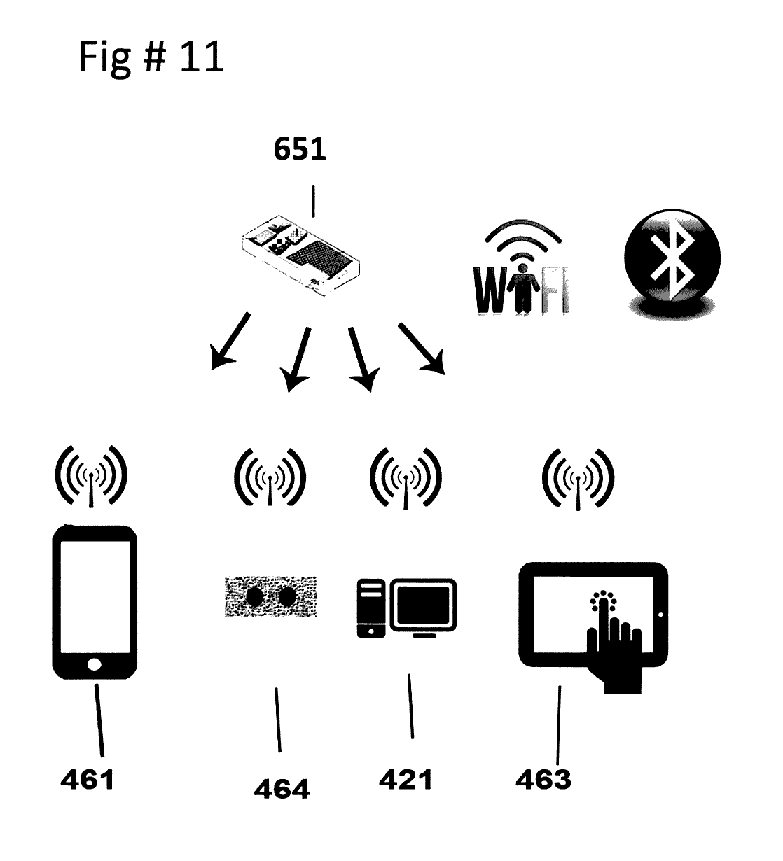

Referring to FIG. 15, illustrated is a diagram with a portable camera connectible by cabling 429 to a portable handheld computer that can be provided in the form of a smartphone 461 or tablet 463 computer.

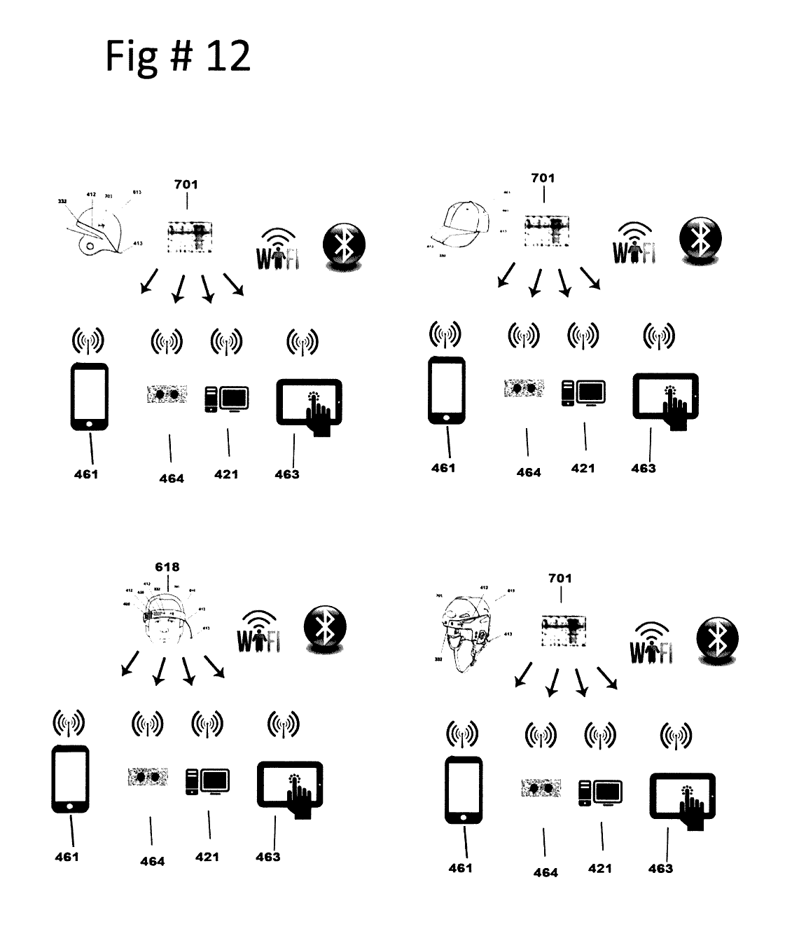

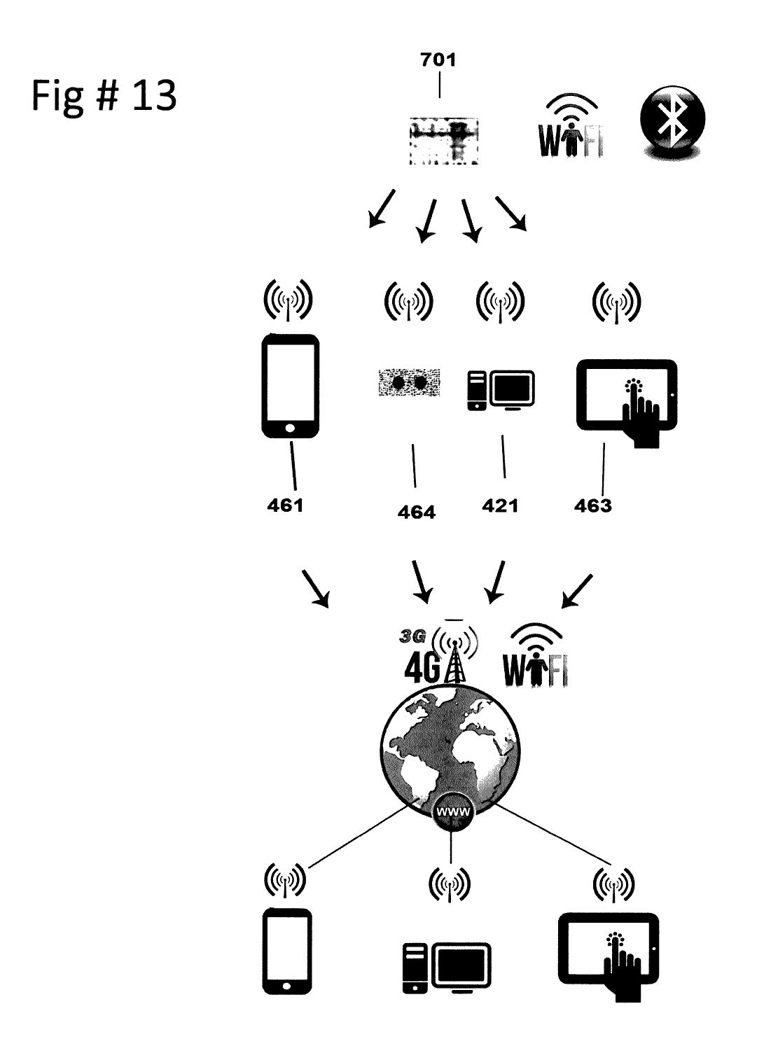

Referring to FIGS. 16 and 17, illustrated is a clip 832 that can be used with a portable camera 332 for attachability of the camera to a person's clothing (e.g., headgear). Also illustrated is optional connection of the camera 332 to a portable electronic unit 450 with a cable 429, wherein the portable electronic unit 450 can support power, processing, and wireless communications for the camera 332 when in use.

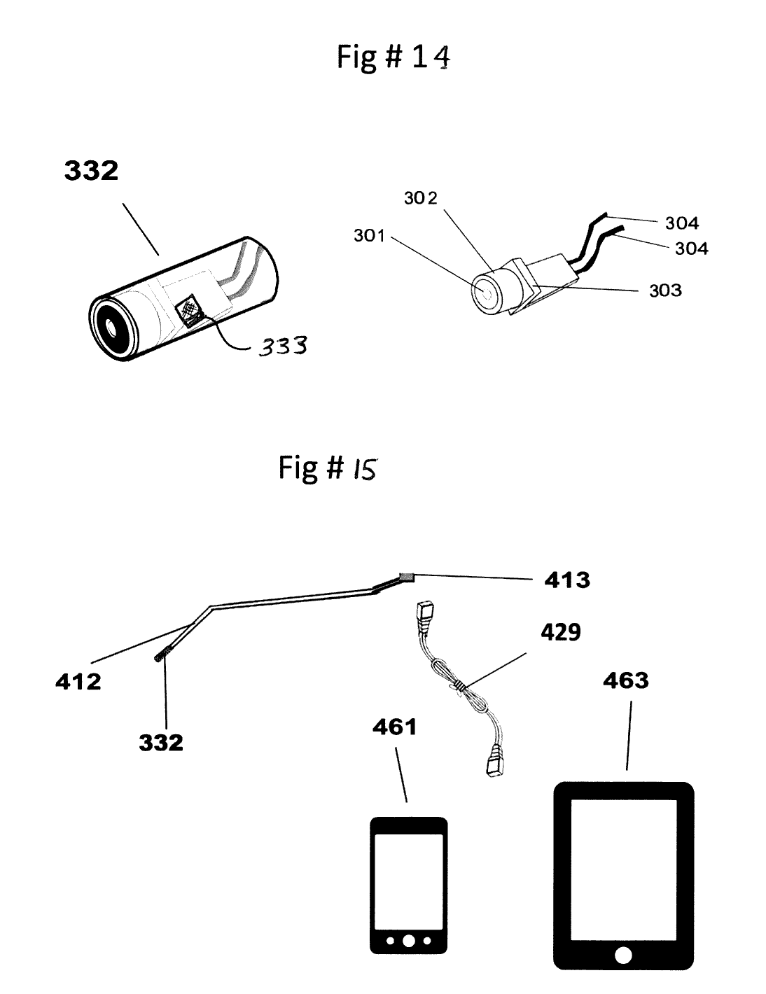

Referring to FIG. 18, illustrated is a baseball cap 403 with a portable camera 332 attached thereto by a clip 832 and optional wired connectivity by cable 412 to a handheld computer 461.

FIG. 19 illustrates eyeglasses 501 with a portable camera 332 attached by clip 832 thereto and optional wired connectivity by cable 412 to a handheld computer 461.

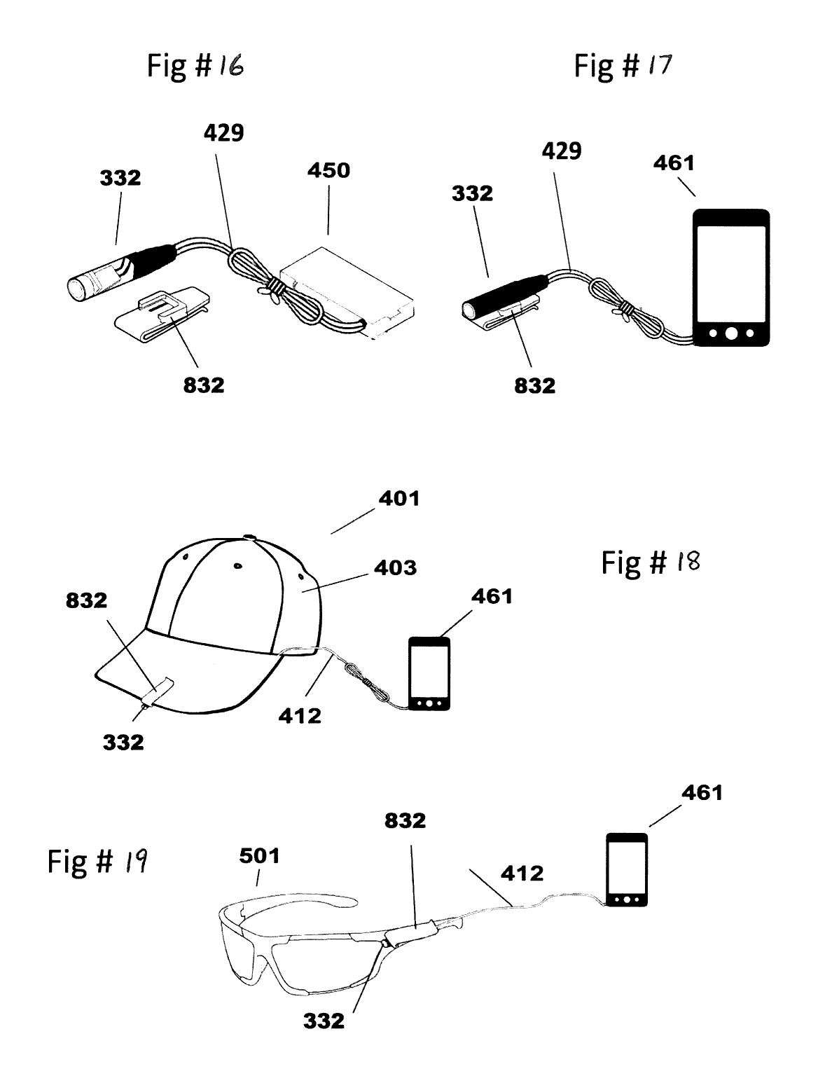

FIG. 20 illustrates features of a portable camera with integrated processing capabilities 850. Shown in a housing can include a camera 420, a communication module 408, rechargeable battery 414, cabling 412, and connection port 413. A clip 832 can be used to attach the camera 850 to a user. The communications module 408 can support communications of the portable camera with integrated processing capabilities 850 to either of a smartphone 461 or tablet computer 463.

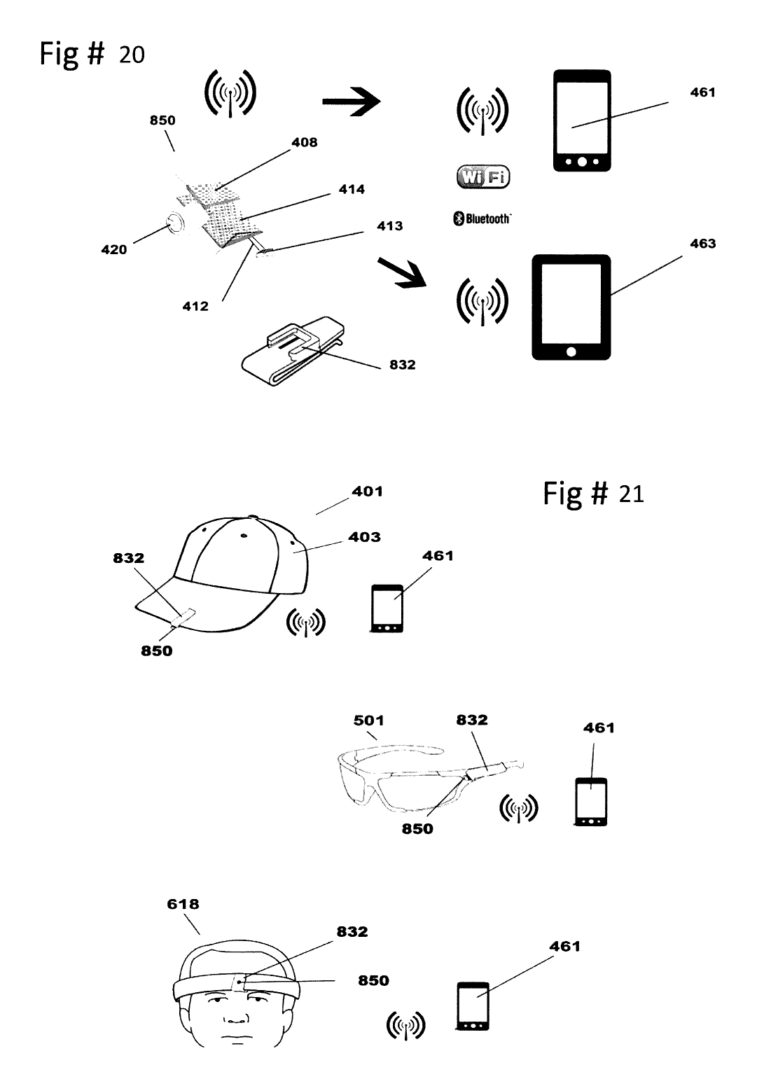

FIG. 21 illustrates a portable camera with integrated processing capabilities 858 clipped to various headgear 403/501/618, with optional wireless connectivity to a handheld computer 461.

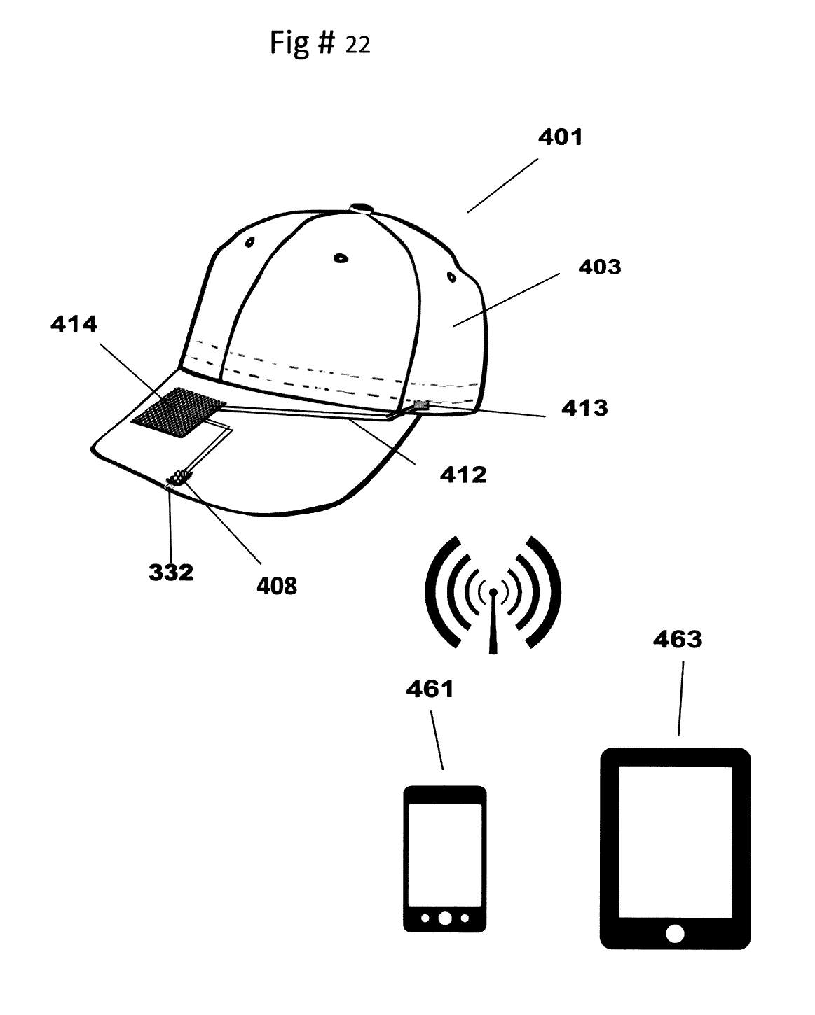

FIG. 22 illustrates a baseball cap 401 with an integrated headgear camera 332 incorporated in the bill of the hat and optional wireless connectivity via communications module 408 to a handheld computer 461/463.

FIG. 23 illustrates a baseball cap 401 with an integrated headgear camera 332 and optional wired connectivity via cable 429 to a handheld computer 461/463.

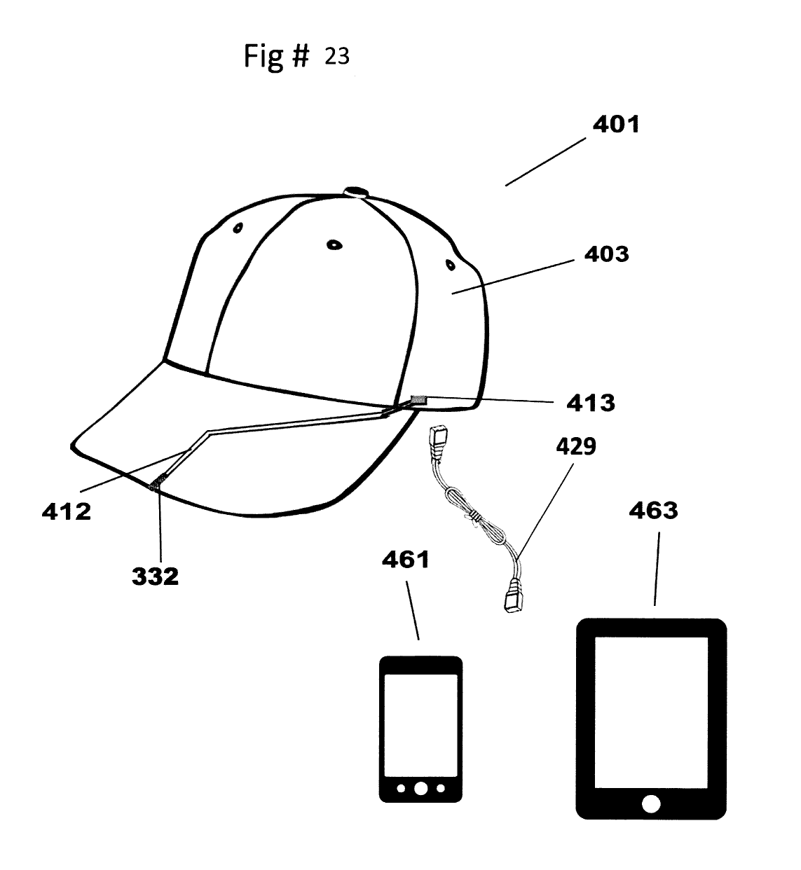

FIG. 24 illustrates a portable camera 332 directly attached to a portable electronic unit 450 via cabling 429 that can support any of: providing power, processing data (e.g., voice and video), and transmitting data to remote computers (e.g., servers, handheld computers).

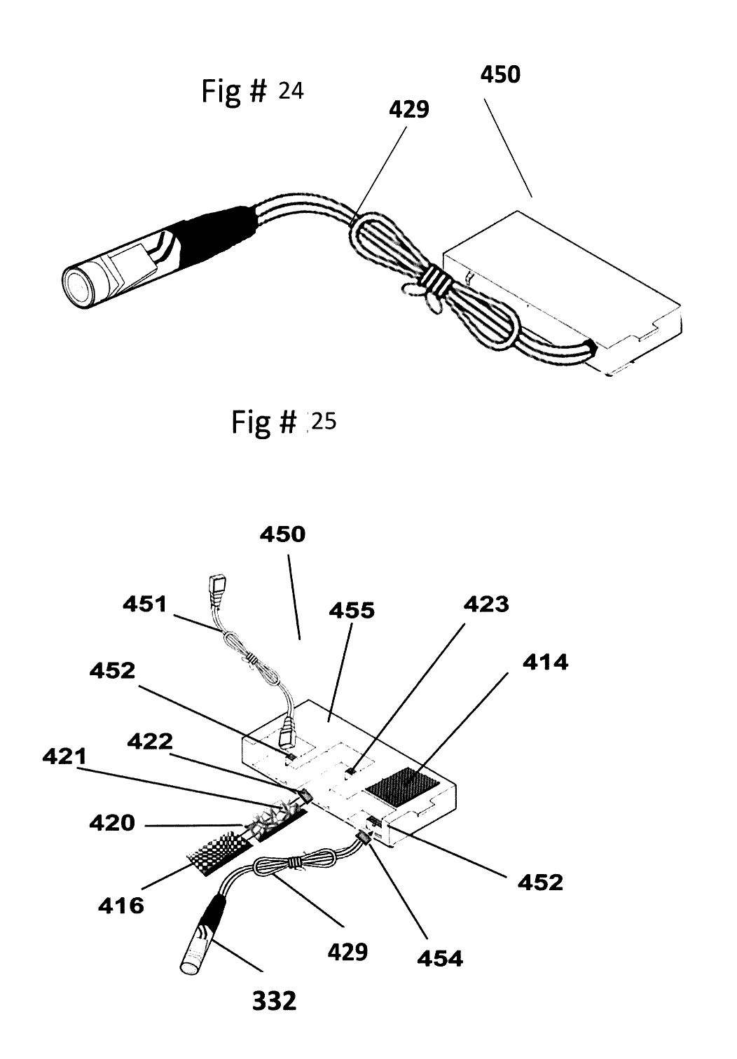

FIG. 25 illustrates a portable electronic unit 450 that can support any of providing power, processing data (e.g., voice and video), and transmitting data to remote computers (e.g., servers, handheld computers). The portable unit can utilize a cable 451 for charging the unit or transferring data. Connector (e.g., plugs) 452 enable data connection via cabling 4291451. Rechargeable battery 414 provides power. Modules 422/420/421/416 can provide communications (wire/wireless), data processing, and audio/video control, and memory storage.

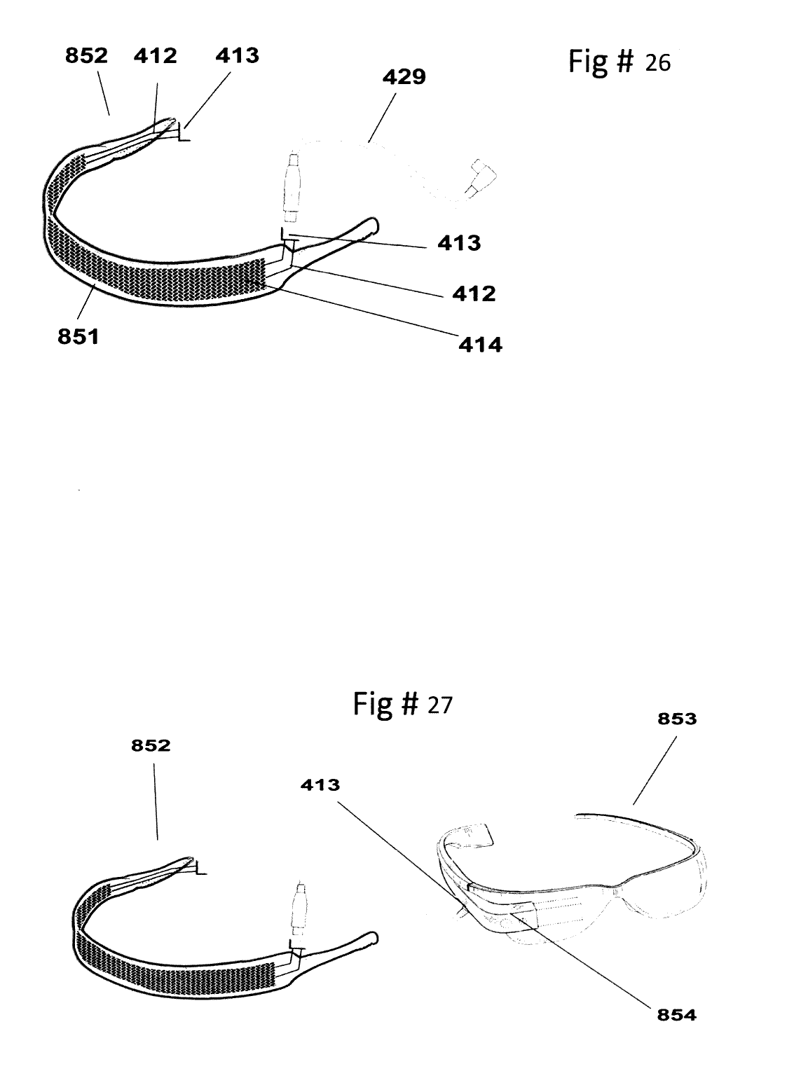

FIG. 26 illustrates a power accessory 852 that can be worn in association with headgear that can provide solar power from a panel 851, or can serve as a battery 414 (flat formed) to portable cameras and processing units via cabling 429.

FIG. 27 illustrates a power accessory 852 connected via cabling to headgear 853 shown for exemplary purposes as Google glass having a camera and microphone capability 854 therein to provide solar power to portable cameras and processing units located therein.

1. A headgear mountable camera including: a camera, a clip to attach the camera to headgear worn by a user, and means to communicate with at least one of a processing unit or a portable computer.

2. The headgear mountable camera of claim 1, further comprising image processing module to process captured video and a wireless communications module to facilitate wireless data communications of video and audio to remote clients including smartphones and tablet computers, wherein the head mounted camera is mounted in at least one of a sweatband, helmet, goggles, hat, and glasses via the clip.
